(19) United States
(12) Patent Application Publication
(10) Pub. No.: US 2025/0141174 A1
(43) Pub. Date: May 1, 2025

(54) OPTICAL AMPLIFIER

(71) Applicant: NIPPON TELEGRAPH AND TELEPHONE CORPORATION, Tokyo (JP)

(72) Inventors: Taiji SAKAMOTO, Musashino-shi, Tokyo (JP); Ryota IMADA, Musashino-shi, Tokyo (JP); Shinichi AOZASA, Musashino-shi, Tokyo (JP); Kazuhide NAKAJIMA, Musashino-shi, Tokyo (JP)

(73) Assignee: NIPPON TELEGRAPH AND TELEPHONE CORPORATION, Tokyo (JP)

(21) Appl. No.: 18/836,969

(22) PCT Filed: Feb. 17, 2022
(86) PCT No.: PCT/JP2022/006380

§ 371 Date: Aug. 8, 2024

(51) Int. Cl. H01S 3/094; H01S 3/067

(52) U.S. Cl. CPC H01S 3/094007; H01S 3/06708

(57) ABSTRACT

The present disclosure is an optical fiber amplifier including: an amplification optical fiber doped with a rare earth element, in which a pump light combiner for injecting multimode pump light into a cladding region of the amplification optical fiber is connected to an input end or an output end of the amplification optical fiber, and a reflective device for reflecting the pump light and transmitting signal light is connected to an end part, of the amplification optical fiber, to which the pump light combiner is not connected.

### TECHNICAL FIELD

The present disclosure relates to an optical fiber amplifier.

### BACKGROUND ART

In an optical fiber communication system, long-distance transmission is performed by relay while light, suffering a loss, propagating through an optical fiber is amplified by an optical amplifier at every fixed distance. In the amplification in the optical amplifier, signal light and pump light for exciting a rare earth element are injected into an amplification optical fiber in which a core region is doped with the rare earth element (An erbium-doped optical fiber (EDF), using erbium, is mainly adopted.) (Light with 980 nm or 1480 nm is mainly adopted as the pump light in a case of EDF), and the signal light is amplified without being converted into electricity.

In current communication using a single mode optical fiber (SMF), a core pumping type optical amplifier that amplifies signal light propagating through a core by similarly guiding pump light through the core is used. On the other hand, in recent years, in order to expand the transmission capacity of an optical fiber, optical fibers for space division multiplexing (SDM) such as a multicore fiber having a plurality of cores in a cross-section of the optical fiber and a few-mode fiber in which two or more modes propagating in the core have been studied, and optical fiber amplifiers applicable to these SDM optical fibers have been studied (for example, Non Patent Literature 1).

Further, in order to simultaneously amplify plural pieces of pieces of signal light propagating through the optical fiber for SDM, a cladding pumping type optical fiber amplifier that guides pump light through a cladding region of the optical fiber has been studied (for example, Non Patent Literature 2). The cladding pumping type optical fiber amplifier can use a multimode light source for pump light, gives power efficiency superior to that of a single mode light source generally used in a core pumping type, does not always require temperature control using a Peltier element necessary for the single mode light source, and is expected to exhibit excellent amplification efficiency (for example, Non Patent Literature 3).

However, compared with the core pumping type optical fiber amplifier, has a problem that the amount of pump light to be absorbed into the amplification optical fiber is reduced due to a small overlap between a region through which pump light propagates and a core region through which signal light propagates.

So far, a regenerative type optical fiber amplifier has been studied in which residual pump light, not absorbed into the amplification optical fiber but transmitted to the output side, of the injected pump light is extracted with a regeneration apparatus and is injected again into the input side of the amplification optical fiber (for example, Non Patent Literature 4). However, in the regenerative type optical fiber amplifier of Non Patent Literature 4, most of the residual pump light is lost by the time of injection of the residual pump light into the amplification optical fiber, and thus there is a problem that the amplification efficiency of the optical fiber amplifier is low.

### CITATION LIST

### Non Patent Literature

Non Patent Literature 1: Y. Tsuchida et al., “Amplification characteristics of a multi-core erbium-doped fiber amplifier”, in Proc. of OFC2012, paper OM3C.3 (2012) Non Patent Literature 2: K. S. Abedin et al., “Cladding-pumped erbium-doped multicore fiber amplifier”, Opt. Express, vol. 20, No. 18, pp. 20191-20200 (2012) Non Patent Literature 3: Y. Jung et al., “High spatial density 6-mode 7-core fiber amplifier for L-band operation”, J. Lightw. Tecnol., vol. 38, No. 11, pp. 2938-2943 (2020)
Non Patent Literature 4: H. Takeshita et al., “Configuration of pump injection and reinjection for improved amplification efficiency of turbo cladding pumped MC-EDFA”, in Proc. of ECOC2019, paper W.1.C.3 (2019).

### SUMMARY OF INVENTION

### Technical Problem

An object of the present disclosure is to improve the amplification efficiency of a cladding pumping type optical fiber amplifier.

### Solution to Problem

The present disclosure solves the above problems, and in a cladding pumping type optical fiber amplifier, a reflective device is connected to an end surface of an amplification optical fiber on the side different from a side to which a pump light combiner is connected, thereby improving the amplification efficiency of the optical fiber amplifier.

Specifically, an optical fiber amplifier of the present disclosure includes:
an amplification optical fiber doped with a rare earth element,
in which
a pump light combiner for injecting multimode pump light into a cladding region of the amplification optical fiber is connected to an input end or an output end of the amplification optical fiber, and
a reflective device for reflecting the pump light and transmitting signal light is connected to an end part, of the amplification optical fiber, to which the pump light combiner is not connected.

### Advantageous Effects of Invention

In the optical fiber amplifier of the present disclosure, since the reflective device is connected to an end part of the amplification optical fiber, the amplification efficiency of the cladding pumping type optical fiber amplifier can be improved.

### BRIEF DESCRIPTION OF DRAWINGS

FIG. 1A is a configuration example of an optical fiber amplifier.

FIG. 1B is a configuration example of an optical fiber amplifier.

FIG. 2 is a configuration example of an optical fiber amplifier using the regeneration method of Non Patent Literature 4.

FIG. 3A illustrates an example of a configuration of an optical fiber amplifier of the present disclosure.

FIG. 3B illustrates an example of a configuration of an optical fiber amplifier of the present disclosure.

FIG. 4 illustrates a configuration example of a reflective device.

FIG. 5 illustrates a configuration example of a pump light combiner.

FIG. 6 is an example of an absorption rate of pump light in an amplification optical fiber with respect to residual coefficient s.

FIG. 7 is an example of reflection efficiency R with respect to residual coefficient s.

FIG. 8 illustrates an example of the number of cores a and a cladding diameter at which the residual coefficient s is 0.9 or less.

### DESCRIPTION OF EMBODIMENTS

Hereinafter, embodiments of the present disclosure will be described in detail with reference to the drawings. Note that the present disclosure is not limited to the embodiments described below. These examples are merely examples, and the present disclosure can be implemented in a form with various modifications and improvements based on the knowledge of those skilled in the art. Note that components having the same reference numerals in the present specification and the drawings indicate the same components.

### First Embodiment Example

Hereinafter, embodiments of the present disclosure will be described with reference to the drawings.

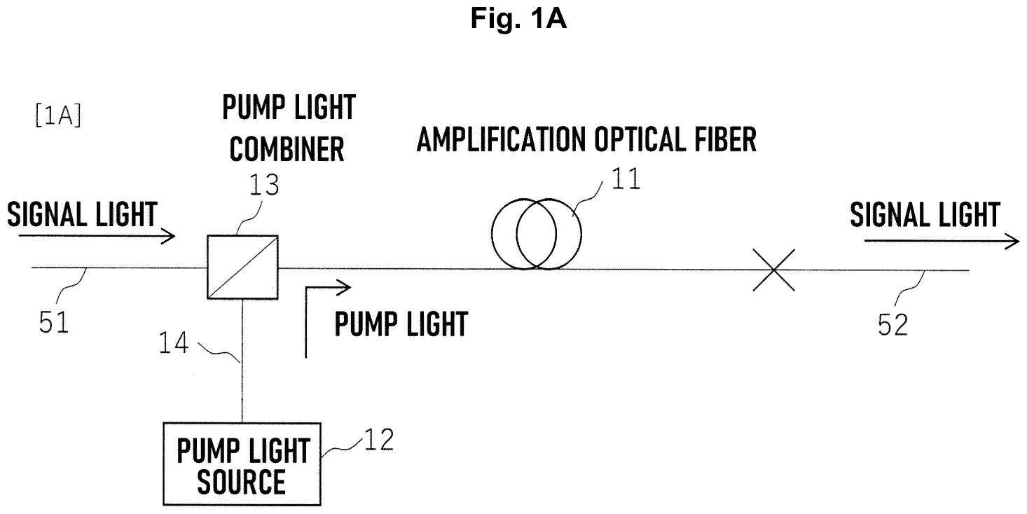

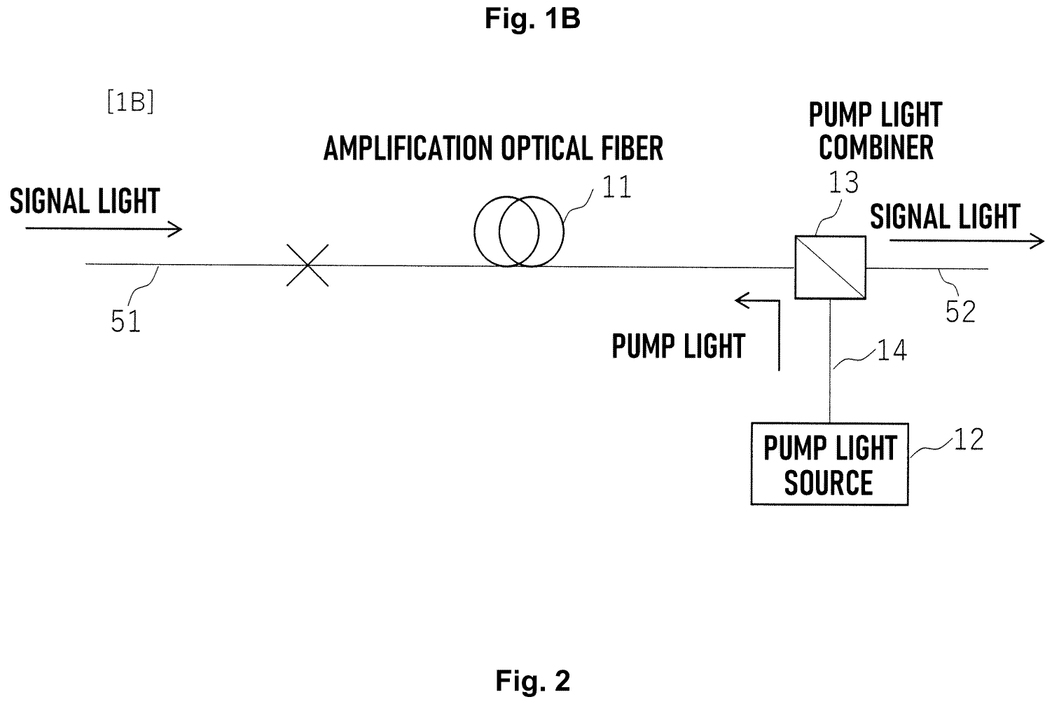

FIGS. 1A and 1B illustrate a configuration example of a conventional cladding pumping type optical fiber amplifier. In the conventional cladding pumping type optical fiber amplifier, a pump light combiner 13 that injects pump light, from a pump light source 12, into a cladding region of an amplification optical fiber 11, doped with a rare earth element, is connected to either an input end or an output end of the amplification optical fiber 11, and signal light, guided through a core of the amplification optical fiber 11, is amplified.

FIGS. 1A and 1B illustrate a forward pumping type in which pump light is injected into an input side of signal light and a backward pumping type in which pump light is injected into an output side, respectively. In general, in order to inject multimode light, from the pump light source 12, into the cladding region of the amplification optical fiber 11, a multimode fiber 14 having a core having a diameter of 105 μm is connected between the pump light source 12 and the pump light combiner 13.

Note that an isolator, which is typically connected to the input end or the output end of the amplification optical fiber 11 in accordance with a propagation direction of the signal light, is omitted in the present disclosure. In addition, a residual pump light remover may be installed to emit the pump light, not absorbed by the amplification optical fiber 11, out of the amplification optical fiber 11.

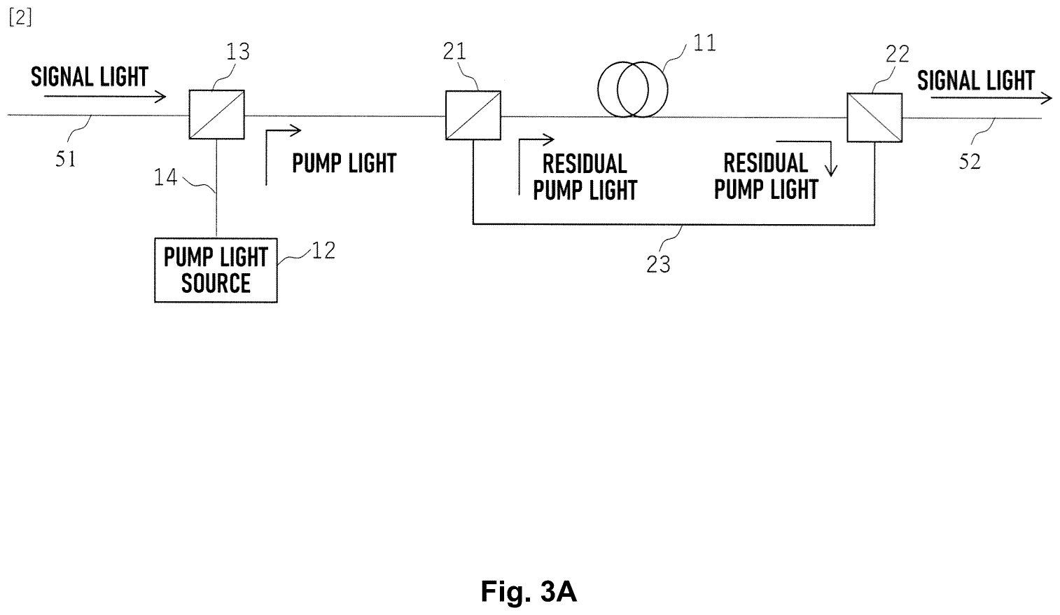

FIG. 2 is a configuration example of a regenerative type optical fiber amplifier of Non Patent Literature 4. For simplicity, only a forward pumping type configuration is illustrated. The signal light and the residual pump light are separated by a regeneration apparatus 22 installed at the output end of the amplification optical fiber 11, and the residual pump light is coupled to the amplification optical fiber 11 by a second pump light combiner 21.

In this regard, a multimode fiber (not illustrated) having a core having a diameter of 105 μm is generally used, and the residual pump light, propagating through the cladding of the amplification optical fiber 11, is guided once again through the core of a multimode fiber 23, and is re-input to the amplification optical fiber 11 via the second pump light combiner 21 installed on the input side. At this time, it is difficult for the residual pump light to be injected via the second pump light combiner 21 without affecting the pump light from the pump light combiner 13, and Non Patent Literature 4 discloses that the regeneration efficiency of the regeneration apparatus 22 and the second pump light combiner 21 is 47.5% as a whole.

Here, in FIG. 2, the regeneration efficiency is the efficiency at which the residual pump light power having passed through the amplification optical fiber 11 is injected into the amplification optical fiber 11. Specifically, given that the proportion of the residual pump light power extracted by the regeneration apparatus 22 and propagated through the multimode fiber 23 is x and the proportion of the pump light injected into on the amplification optical fiber 11 via the second pump light combiner 21 and again injected into the amplification optical fiber 11 via the multimode fiber 23 is y, the regeneration efficiency can be calculated by multiplying x and y.

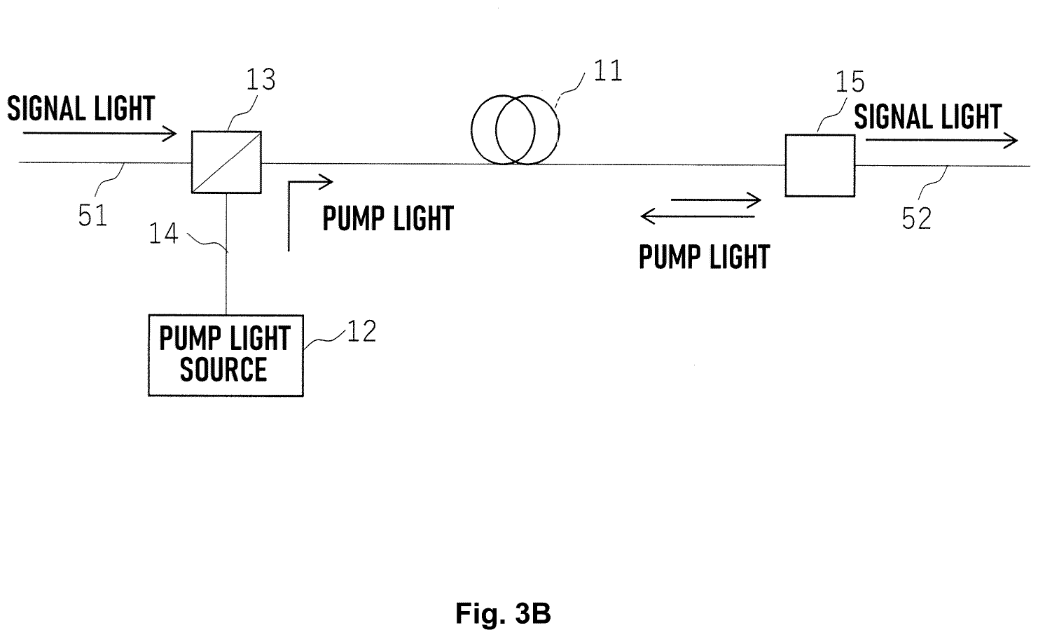

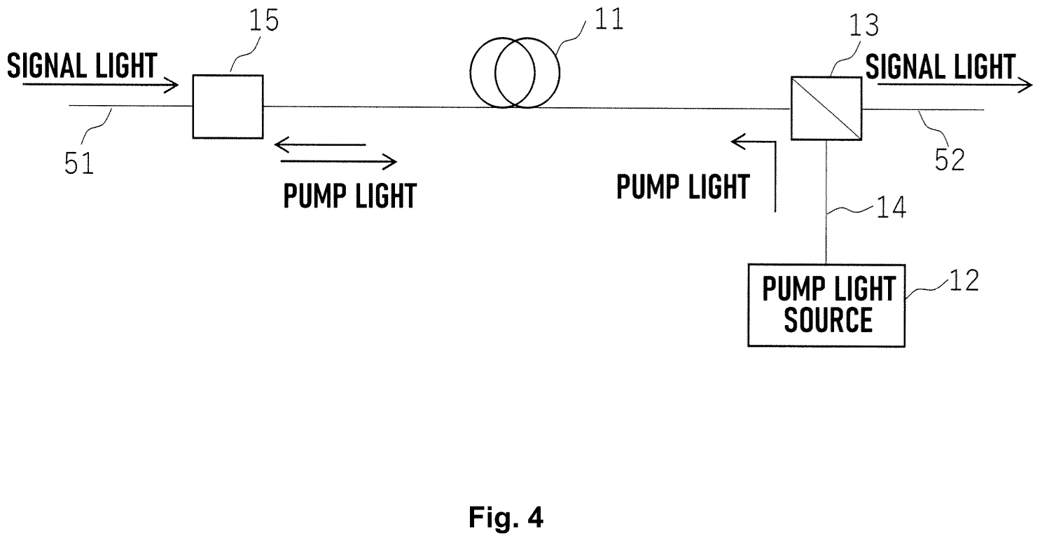

FIGS. 3A and 3B illustrate an example of a configuration of an optical fiber amplifier of the present disclosure. An optical fiber amplifier of the present disclosure includes:
the amplification optical fiber 11 doped with a rare earth element;
the pump light source 12 that supplies pump light for amplifying signal light in the amplification optical fiber 11;
the pump light combiner 13 that injects the pump light, from the pump light source 12, into the cladding of the amplification optical fiber 11; and
a reflective device 15 that reflects the pump light and transmits the signal light.

The reflective device 15 is connected to an end part, of the amplification optical fiber 11, to which the pump light combiner 13 is not connected.

FIG. 3A is an example of a forward pumping type in which pump light is injected into an input side of signal light, and illustrates an example in which the pump light combiner 13 is connected to an input end of the amplification optical fiber 11. In this example, the reflective device 15 is connected to the output end of the amplification optical fiber 11, transmits the signal light amplified by the amplification optical fiber 11, and reflects the residual pump light, completely passing through the amplification optical fiber 11, on the amplification optical fiber 11.

FIG. 3B is an example of a backward pumping type in which pump light is injected into an output side of signal light, and illustrates an example in which the pump light combiner 13 is connected to an output end of the amplification optical fiber 11. In this example, the reflective device 15 is connected to the input end of the amplification optical fiber 11, transmits the signal light, yet to be amplified, to the amplification optical fiber 11, and reflects the residual pump light, completely passing through the amplification optical fiber 11, on the amplification optical fiber 11.

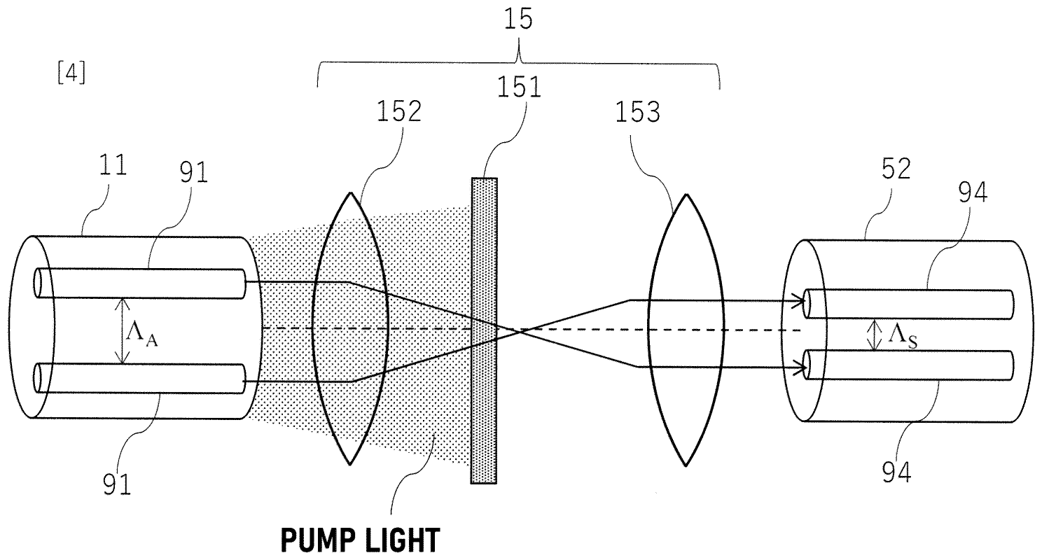

FIG. 4 illustrates a configuration example of the reflective device 15. In the present drawing, an example of a forward pumping type is illustrated. The reflective device 15 includes a pump light reflection filter 151 and lenses 152 and 153. The pump light reflection filter 151 is a wavelength filter that reflects the pump light wavelength and transmits the communication light wavelength. The pump light reflection filter 151 reflects the pump light, emitted from the amplification optical fiber 11, on the cladding of the amplification optical fiber 11. In the present disclosure, since the pump light propagates through the cladding, the residual pump light is emitted and spreads out from the output end of the amplification optical fiber 11. Therefore, the pump light reflection filter 151 has a diameter larger than the cladding diameter of the amplification optical fiber 11.

In the present disclosure, when transmission path optical fibers 51 and 52 are multicore fibers, the amplification optical fiber 11 is a multicore fiber having the same number of cores as that of the transmission path optical fiber 51. Since the reflective device 15 includes the lenses 152 and 153, signal light propagated through each core 91 of the amplification optical fiber 11 can be coupled to each core 94 of the transmission path optical fiber 52 on the output side.

Even in the backward pumping type, the configuration same as the configuration of the reflective device 15 in the forward pumping type can be used with the configuration of the transmission path optical fiber 52 replaced with the configuration of the transmission path optical fiber 51. In addition, the reflective device 15 of the present embodiment is not limited to the spatial reflective device 15, and any configuration suitable for the environment of the transmission path can be adopted.

With the configuration of the present disclosure, since the residual pump light is regenerated in the backpropagation direction of the optical fiber having the same structure, a multimode fiber for injecting multimode light into the cladding region of the amplification optical fiber 11 is not needed. Thus, since the configuration in the present disclosure has no factor that degrades the regeneration efficiency as compared with the configuration illustrated in FIG. 2, the residual pump light can be re-input to the amplification optical fiber 11 with the regeneration efficiency close to 100% at the reflective device 15. Thus, the present embodiment can greatly improve the amplification efficiency with respect to the input pump light power.

Note that, the present embodiment, where the amplification optical fiber 11 is a multicore fiber, has been described, but the present disclosure can be applied to any SDM optical fiber. For example, the transmission path optical fibers 51 and 52 and the amplification optical fiber 11 may be few-mode fibers having one core. For example, the transmission path optical fibers 51 and 52 and the amplification optical fiber 11 may be multicore fibers having the same number of cores. For example, the transmission path optical fibers 51 and 52 and the amplification optical fiber 11 may be multicore fibers having the same number of cores, each of which is capable of propagation of two or more modes.

### Second Embodiment Example

As illustrated in FIG. 4, an inter-core distance Λ_{A} of the amplification optical fiber 11 may be different from an inter-core distance Λ_{S} of the transmission path optical fiber 52. In this regard, the amplification optical fiber 11 and the transmission path optical fiber 52 having different inter-core distance can be connected by adjusting the focal distances and the arrangement locations of the lenses 152 and 153.

Even in the backward pumping type, the configuration same as the configuration of the reflective device 15 in the forward pumping type can be used with the configuration of the transmission path optical fiber 52 replaced with the configuration of the transmission path optical fiber 51. In addition, the reflective device 15 of the present embodiment is not limited to the spatial reflective device 15, and any configuration according to the environment of the transmission path can be adopted.

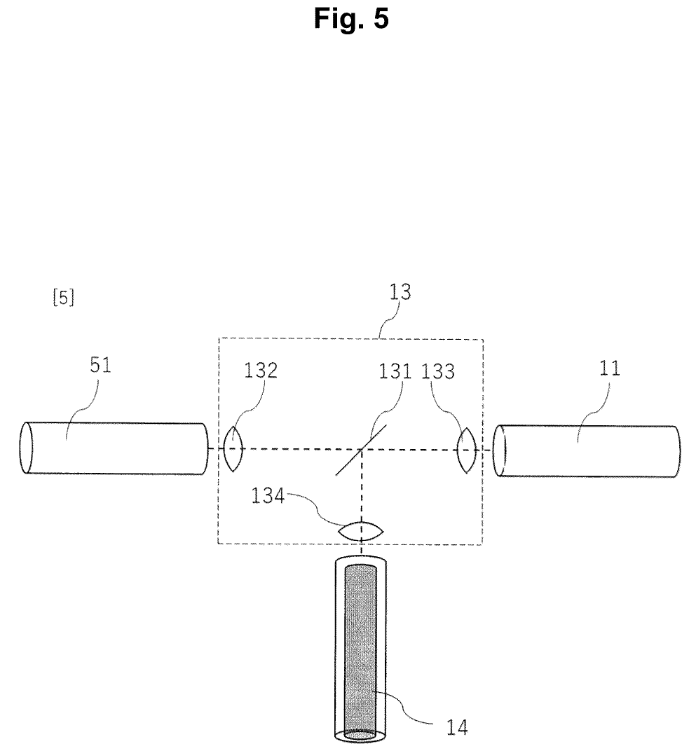

FIG. 5 illustrates a configuration example of the pump light combiner 13. In the present drawing, an example of a forward pumping type is illustrated. The pump light combiner 13 includes a dichroic mirror 131 and lenses 132, 133, and 134. The dichroic mirror 131 is arranged on an optical path between an output end of the transmission path optical fiber 51 and an input end of the amplification optical fiber 11, and couples the pump light, from the multimode fiber 14, to the input end of the amplification optical fiber 11. As a result, the signal light from the transmission path optical fiber 51 and the pump light from the multimode fiber 14 are injected into the amplification optical fiber 11.

Here, when the amplification optical fiber 11 is a multicore fiber, the inter-core distance of the amplification optical fiber 11 and the inter-core distance of the transmission path optical fiber 51 may be different. In this regard, the transmission path optical fiber 51 and the amplification optical fiber 11 having different inter-core distance can be connected by adjusting the focal distances and the arrangement locations of the lenses 132 and 133.

Even in the backward pumping type, the configuration same as the configuration of the pump light combiner 13 in the forward pumping type can be used with the configuration of the transmission path optical fiber 51 replaced with the configuration of the transmission path optical fiber 52. In addition, the pump light combiner 13 of the present embodiment is not limited to the spatial pump light combiner 13, and any configuration according to the environment of the transmission path can be adopted.

### Third Embodiment Example

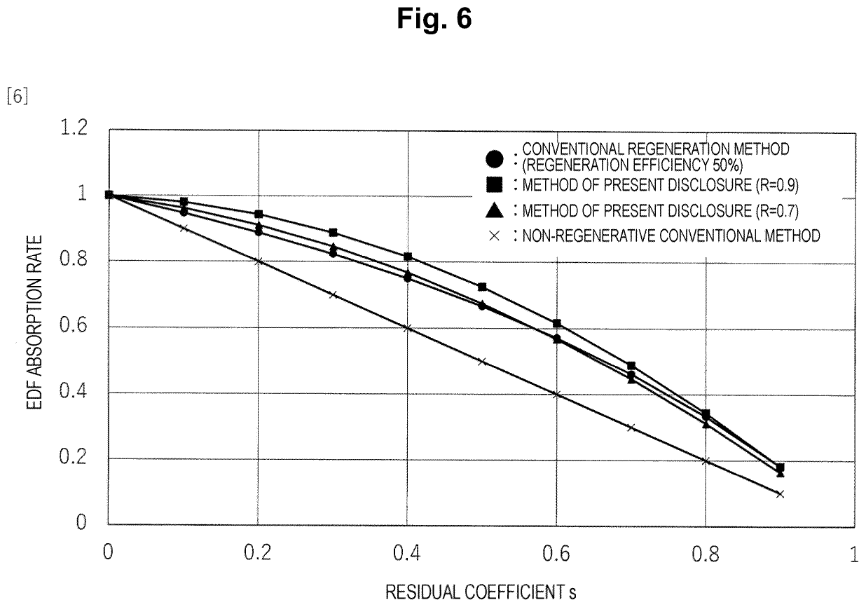

FIG. 6 illustrates a result of calculating the absorption rate of the pump light in the amplification optical fiber 11 with respect to residual coefficient s=Pₚ₁/Pₚ₀. The residual coefficient s is a ratio of the output power Pₚ₁ of the residual pump light, completely passing through the amplification optical fiber 11, to the input power Pₚ₀ of the pump light input, from the pump light source 12, to the amplification optical fiber 11. In the present disclosure, the input power Pₚ₀ may be referred to as pump light input power, and the output power Pₚ₁ may be referred to as residual pump light output power.

Here, the absorption rate of the pump light indicates how much pump light is absorbed in total into the amplification optical fiber 11 by regeneration or reflection. Regarding the reflective device 15 of the present embodiment, the absorption rate obtained by adding up the absorption into the amplification optical fiber 11 in the forward path and the backward path is used. In addition, in the regeneration method illustrated in FIG. 2, on the assumption that the multimode fiber 23 and the amplification optical fiber 11 constitute the loop configuration, the sum of geometric sequences based on the regeneration efficiency and the EDF absorption coefficient is used.

In the conventional regeneration method illustrated in FIG. 2, the regeneration efficiency is estimated to be as high as 50% and calculation is performed based on the report results of Non Patent Literature 4 and the like. In addition, with regard to the configuration of the present disclosure, calculation is performed with the reflection efficiency R of the reflective device 15 set to 0.7 and 0.9. In addition, the pump light reflected by the reflective device 15 is assumed to pass through the amplification optical fiber 11 again, to be output to the pump light source 12 side via the pump light combiner 13, and to be removed by the isolator provided in the pump light source 12 or be removed by a pump light isolator installed immediately after the pump light combiner 13.

As illustrated in FIG. 6, when the conventional regeneration method is compared with the configuration of the present disclosure in which the reflection efficiency R is 0.7, the superiority and the inferiority of the absorption rate of the pump light are reversed around the residual coefficient s of 0.55. Specifically, when s<0.55, the absorption rate of the pump light of the present disclosure is superior.

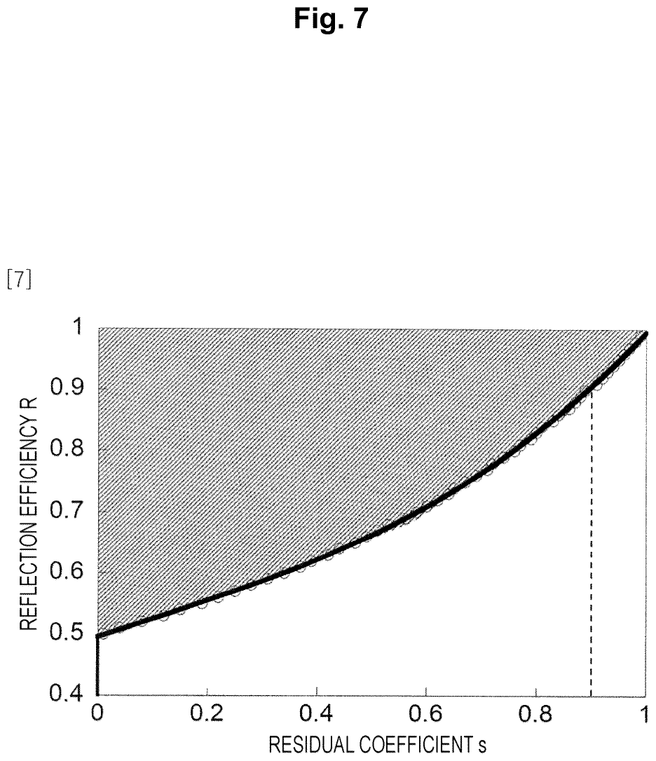

Based on this calculation, the region where the present disclosure is superior is calculated using the residual coefficient s of the amplification optical fiber 11 and the reflection efficiency R of the reflective device 15 of the present disclosure as parameters. Results are illustrated in FIG. 7. The hatched region in the drawing indicates a region in which the absorption rate of the pump light of the present disclosure is superior to that of the conventional regeneration method, and according to the result, it was found that the hatched region is a region in which the following inequality holds.

$$R > 0. 5 + 0.30126 s - 0.06 \; 5695 {s}^{2} + 0.26456 {s}^{3}$$

The experiment confirmed that the reflection efficiency R of the reflective device 15 was 0.9 or more. Therefore, by using the reflective device 15 having the reflection efficiency R of 0.9 or more, the amplification optical fiber 11 having the residual coefficient s of 0.9 or less can exhibit excellent amplification efficiency.

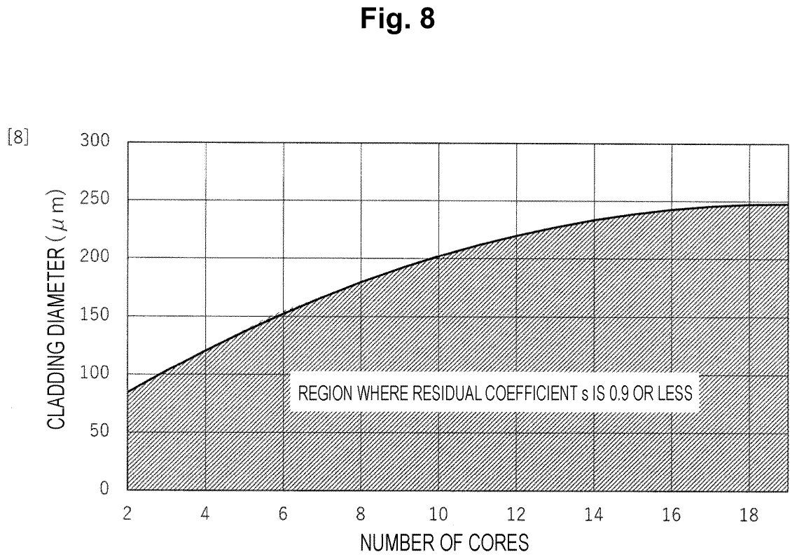

For example, when a single mode single core fiber having a cladding diameter of 125 μm, a core radius of 4.5 μm, and an erbium addition amount of 6×10²⁴ ions/m³ is used, the residual coefficient s is 98% on the assumption that the fiber length is adjusted to 8 m, the pump light is 980 nm, the pump light input power is 10 W, and the signal light input power to the amplification optical fiber 11 is −6 dBm/core so as to amplify 1530 to 1565 nm. FIG. 8 illustrates a result of calculation, under a condition that the residual coefficient s is 0.9 with respect to the number of cores, in a multicore structure with the same core structure and the same amount of erbium dopant.

From the curve illustrated in FIG. 8, the multicore fiber satisfying the condition of the expression described below where the number of cores is a and the cladding diameter is b μm, even when the reflection efficiency R of the reflective device 15 is 0.9 or less, can achieve the amplification efficiency superior to that of the conventional regeneration method.

$$b < - 0.5653 \times {a}^{2} + 21.47 \times a + 43.92$$

Note that black (x plot) in FIG. 6 indicates the absorption rate of the pump light in the case of non-regenerative example, in which regeneration as illustrated in FIGS. 1A and 1B is not performed. When the absorption rate of the pump light into the amplification optical fiber 11 of the present disclosure is compared with that of the non-regenerative conventional method, the absorption rate of the pump light can be improved by 10% or more in the range of the residual coefficient s of 0.1 to 0.9 and by 18% or more in the range of 0.1 to 0.8.

### INDUSTRIAL APPLICABILITY

The present disclosure can be applied to information and communication industries.

### REFERENCE SIGNS LIST

11 Amplification optical fiber
12 Pump light source
13 Pump light combiner
131 Dichroic mirror
132, 133, 134 Lens
14 Multimode fiber
15 Reflective device
151 Pump light reflection filter
152, 153 Lens
21 Second pump light combiner
22 Regeneration apparatus
23 Multimode fiber
51, 52 Transmission path optical fiber

1. An optical fiber amplifier comprising:
an amplification optical fiber doped with a rare earth element,
wherein
a pump light combiner for injecting multimode pump light into a cladding region of the amplification optical fiber is connected to an input end or an output end of the amplification optical fiber, and
a reflective device for reflecting the pump light and transmitting signal light is connected to an end part, of the amplification optical fiber, to which the pump light combiner is not connected.

2. The optical fiber amplifier according to claim 1, wherein,
given that input power of pump light, input to the amplification optical fiber, is Pₚ₀ and output power of residual pump light, completely passing through the amplification optical fiber, is Pₚ₁, reflection efficiency R of the pump light in the reflective device satisfies
R>0.5+0.30126s-0.065695s²+0.26456s³
with respect to residual coefficient s=Pₚ₁/Pₚ₀.

3. The optical fiber amplifier according to claim 1, wherein
the reflective device includes a pump light reflection filter for reflecting the pump light and transmitting the signal light, and
a region, for reflecting the pump light, of the pump light reflection filter is broader than the cladding region of the amplification optical fiber, and
the pump light reflection filter reflects the pump light, emitted from the amplification optical fiber, on the cladding region of the amplification optical fiber.

4. The optical fiber amplifier according to claim 1, wherein the amplification optical fiber is a multicore fiber having two or more cores in an optical fiber cross-section thereof.
